(19) United States
(12) Patent Application Publication
(10) Pub. No.: US 2017/0184992 A1
(43) Pub. Date: Jun. 29, 2017

(54) IMAGE FORMING APPARATUS

(71) Applicant: Oki Data Corporation, Tokyo (JP)

(72) Inventor: Daiki MORIMOTO, Tokyo (JP)

(21) Appl. No.: 15/384,231

(22) Filed: Dec. 19, 2016

(30) Foreign Application Priority Data
Dec. 25, 2015 (JP) 2015-253922
Oct. 18, 2016 (JP) 2016-204250

(51) Int. Cl. G03G 15/02

(52) U.S. Cl. CPC G03G 15/0233

(57) ABSTRACT

An image forming apparatus includes an electrostatic latent image carrier that carries an electrostatic latent image, a charging member that charges the electrostatic latent image carrier by contacting with the electrostatic latent image carrier, the charging member being rotatable around an axis, and a development part that develops the electrostatic latent image by having a developer adhere to the electrostatic latent image. The charging member comprises an axial body that rotates around the axis, a conductive base layer provided around the axial body, and a surface layer provided on an outer circumferential face of the conductive base layer, and surface projections are formed on the surface layer, of which a projection height distribution includes at least two peaks.

### CROSS REFERENCE TO RELATED APPLICATIONS

This application claims priority under 35 USC 119 to Japanese Patent Applications No. 2015-253922 filed on Dec. 25, 2015 and No. 2016-204250 filed on Oct. 18, 2016, the entire contents which are incorporated herein by reference.

### TECHNICAL FIELD

This invention especially relates to a charging member that charges a photosensitive drum in an image forming apparatus employing an electrophotographic system.

### BACKGROUND

Among conventional image forming apparatuses such as printers and copiers that employ an electrophotographic system, there were those that formed recesses and projections by dispersing particles on the surface of a charging member for stabilizing the charging characteristics to a photosensitive body that is an electrostatic latent image carrier.

### RELATED ART

### Patent Document(s)

[Patent Document] Japanese Laid-Open Patent Application Publication 2011-17961

However, in the conventional technology, there were cases where a charging lateral streak derived from the charging member occurred on a printed image, making it difficult to obtain a fine printed image.

This invention was made considering such an actual situation, and its objective is to offer an image forming apparatus that can suppress the occurrences of streaks on printed images derived from a charging member and allow obtaining fine printed images.

### SUMMARY

An image forming apparatus disclosed in the application includes an electrostatic latent image carrier that carries an electrostatic latent image, a charging member that charges the electrostatic latent image carrier by contacting with the electrostatic latent image carrier, the charging member being rotatable around an axis, and a development part that develops the electrostatic latent image by having a developer adhere to the electrostatic latent image. The charging member comprises an axial body that rotates around the axis, a conductive base layer provided around the axial body, and a surface layer provided on an outer circumferential face of the conductive base layer, and surface projections are formed on the surface layer, of which a projection height distribution includes at least two peaks.

Another image forming apparatus disclosed in the application includes an electrostatic latent image carrier that carries an electrostatic latent image, a charging member that charges the electrostatic latent image carrier by contacting with the electrostatic latent image carrier, the charging member being rotatable around an axis, and a development part that develops the electrostatic latent image by having a developer adhere to the electrostatic latent image. The charging member comprises an axial body that rotates around the axis, a conductive base layer provided around the axial body, and a surface layer provided on an outer circumferential face of the conductive base layer, and in a surface observation image region that is a part of region of the surface layer seen from a microscope, the surface observation image region includes two different projection areas, one of the projection areas being large projection areas each of which is 1000 μm² or larger, and the other of the projection areas being small projection areas each of which is smaller than 1000 μm², an occupied area ratio of the large projection areas, that is determined by how degrees the large projection areas occupying the surface observation image region, is ranged within 3-8%, and an occupied area ratio of the small projection areas, that is determined by how degrees the small projection areas occupying the surface observation image region, is ranged within 10-25%.

This invention can offer an image forming apparatus that can prevent the occurrences of streaks derived from a charging member on printed images and allow obtaining fine images.

### BRIEF DESCRIPTION OF THE DRAWINGS

FIG. 1 is an overall structural diagram to explain the overall configuration of a printer of this embodiment.

FIG. 2 is a cross-sectional view showing primary members of a development device of this embodiment.

FIG. 3 is an outline cross-sectional view to explain the configuration of a charging roller.

FIG. 4 is a diagram showing the measurement result of the projection height distribution of a charging roller in the conventional technology.

FIG. 5 is a diagram showing the measurement result of the projection height distribution of a charging roller in this embodiment.

FIG. 6 is a diagram to explain a print pattern at 5% coverage.

FIG. 7 is a diagram to explain an example of the occurrences of charging lateral streaks.

FIG. 8 is a compilation of the judgment result of the occurrences of charging lateral streaks in the order of time sequence.

FIG. 9 is a model cross-sectional view when one kind of particles are added to the surface layer of the charging roller.

FIG. 10 is a model cross-sectional view when two kinds of particles are added to the surface layer of the charging roller.

FIG. 11 is a model microscope observation image when two kinds of particles are added to the surface layer of the charging roller.

FIG. 12 is a model cross-sectional view when two kinds of particles are added to the surface layer of the charging roller.

### DETAILED DESCRIPTION OF THE PREFERRED EMBODIMENT(S)

Below, embodiments of this invention are explained referring to drawings. Note that this invention is not limited to the following descriptions but can be modified appropriately within a range not deviating from the purpose of this invention.

### First Embodiment

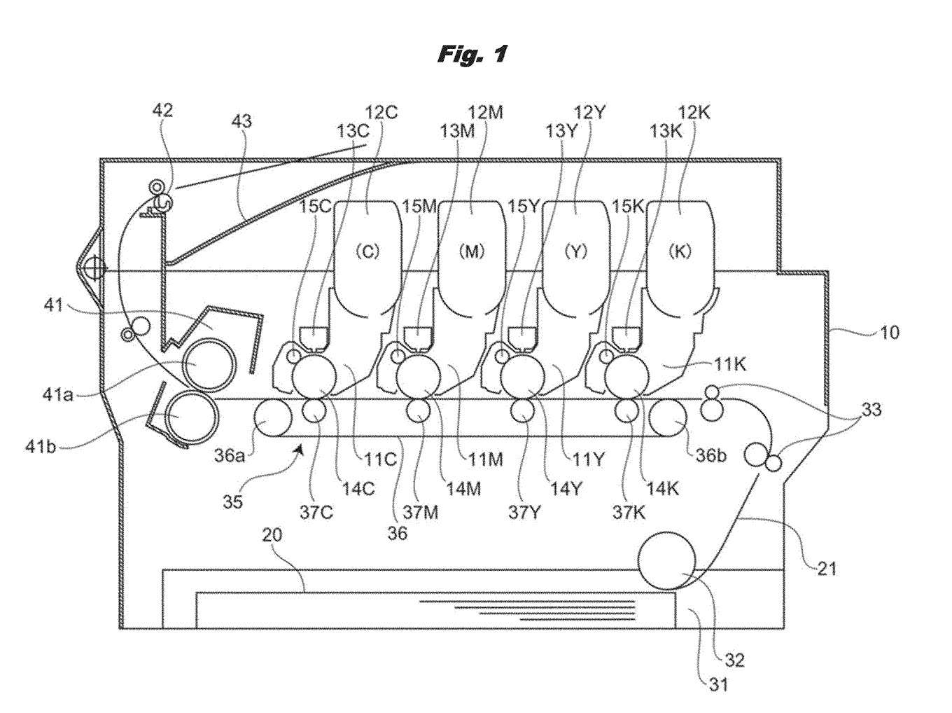

FIG. 1 is an overall structural diagram to explain the overall structure of a printer 100 of the first embodiment. The printer 10 of this embodiment is an image forming apparatus that can form a color image on a recording medium 20 by an electrophotographic system. The printer 10 that realizes such a function is provided with development devices 11K, 11Y, 11M, and 11C as a development part supporting image formation using toners (black (K), yellow (Y), magenta (M), and cyan (C)) as developers, a transfer belt unit 35, a fuser unit 41, etc. along a medium carrying route 21 formed in an approximate S shape starting at a sheet feeding cassette 31 and ending at an ejection roller 42 via a carrying roller 32.

The sheet feeding cassette 31 contains the recording medium 20 inside in a stacked state and is detachably attached to the lower part of the printer 10. Then, a hopping roller 32 provided on the upper part of the sheet feeding cassette 31 extracts one by one the recording medium 20 contained in the sheet feeding cassette 31 from the top part and forwards it to the medium carrying route 21.

A carrying roller 33 corrects skew of the recording medium 20 forwarded from the hopping roller 32 and carries the recording medium 20 to the transfer belt unit 35.

The transfer belt unit 35 is provided with a transfer belt 36, a transfer belt drive roller 36a, a tension roller 36b, and transfer rollers 37K, 37Y, 37M, and 37C. The transfer belt 36 is an endless belt member that electrostatically adsorbs and carries the recording medium 10, and is stretched by the tension roller 36b supported by an unshown spring and the transfer belt drive roller 36a that is disposed forming a pair with the tension roller 36b and rotates driven by an unshown drive motor for keeping the tension of the transfer belt 36 constant. Each of the transfer rollers 37K, 37Y, 37M, and 37C is formed of a conductive rubber or the like and disposed so as to oppose and contact with a photosensitive drum as an electrostatic latent image carrier provided in each development device. Each of the transfer rollers 37K, 37Y, 37M, and 37C transfers a toner image developed on the surface of the photosensitive drum to the recording medium 20 by a bias voltage that is applied from an unshown transfer power supply and has the opposite polarity to the toner.

The fuser unit 41 is disposed in the downstream side of the medium carrying route 21 after the development devices 11K, 11Y, 11M, and 11C, and is provided with a heat application roller 41a, a backup roller 41b, and an unshown temperature sensor, etc. The heat application roller 41 is formed, for example, by coating a hollow cylindrical-shape core metal made of aluminum or the like with a heat-resistant elastic layer of silicone rubber and further with a PFA (tetrafluoroethylene-perfluoroalkylvinylether copolymer) tube. Then, provided inside the core metal is a heater such as a halogen lamp for example. The backup roller 41b has a configuration, for example, where a core metal made of aluminum or the like is coated with a heat-resistant elastic layer of silicone rubber and further with PFA, and is disposed so that a press-contact part is formed between it and the heat application roller 41a. The heat application roller 41a and the backup roller 41b rotate based on the control by an unshown fuser controller. The unshown temperature sensor is a surface temperature detection means for the heat application roller 41a and is disposed contactless in the vicinity of the heat application roller 41a. By controlling the above-mentioned heater based on the detection result of the surface temperature of the heat application roller 41a detected by the unshown temperature sensor, the surface temperature of the heat application roller 41a is maintained at prescribed temperature. The recording medium 20, to which the toner images formed in the development devices 11K, 11Y, 11M, and 11C were transferred, passes through the press-contact part formed by the heat application roller 41a maintained at the prescribed temperature and the backup roller 41b, thereby, heat and a pressure are applied to the toners on the recording medium 20, the toners melt, and the toner images are fused.

The ejection roller 42 nip-carries the recording medium 20 that passed through the fuser unit 41, and ejects the recording medium 20 to an ejection stacker 43 formed by utilizing the outer chassis of the printer 10.

The development devices 11K, 11Y, 11M, and 11C are configured detachably from the printer 10 from the upstream side of the medium carrying route 21. The development devices 11K, 11Y, 11M, and 11C are provided with photosensitive drums 14K, 14Y, 14M, and 14C that can carry electrostatic latent images based on irradiation light radiated from exposure devices 13K, 13Y, 13M, and 13C, respectively. The electrostatic latent images formed on the photosensitive drums 14K, 14Y, 14M, and 14C corresponding to the respective toner colors are developed with toners supplied from their respective toner containers 12K, 12Y, 12M, and 12C and transferred to the recording medium 20 by the transfer rollers 37K, 37Y, 37M, and 37C, respectively. The configurations of the development devices including the toner containers are stated later.

Each of the exposure devices 13K, 13Y, 13M, and 13C is an LED (Light Emitting Diode) head comprising LED light emitting elements and a lens array. Each of the exposure devices 13K, 13Y, 13M, and 13C is disposed in such a position that irradiation light radiated by the LED light emitting elements turning on based on the control by an unshown exposure controller forms an image on the surface of the photosensitive drum provided in each of the development devices.

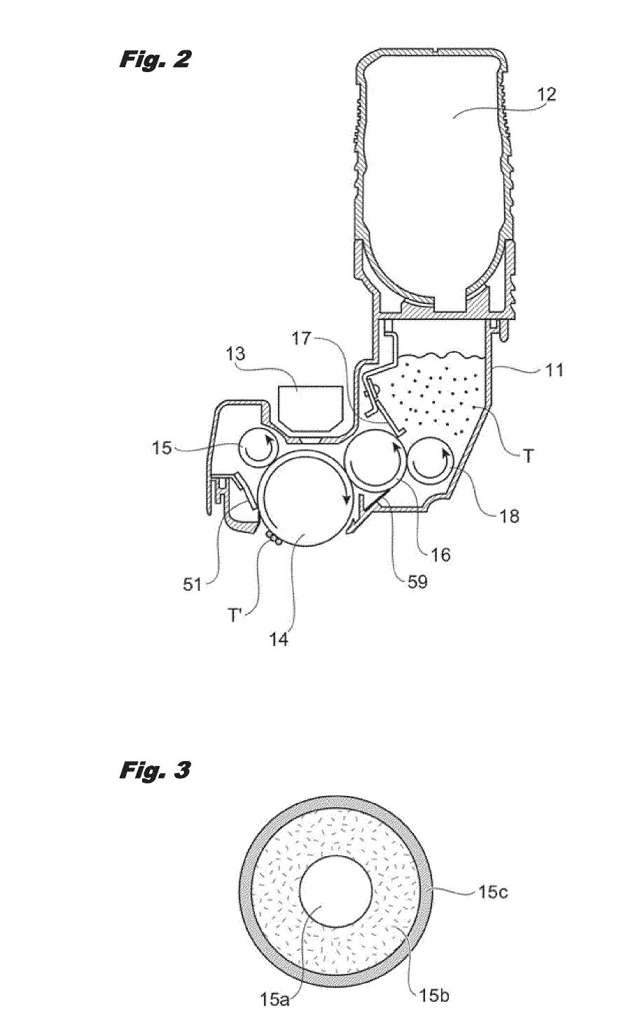

Next, the configurations of the development devices 11K, 11Y, 11M, and 11C are explained. FIG. 2 is a cross-sectional view showing the primary members of the development device 11K, 11Y, 11M, or 11C including the toner container 12K, 12Y, 12M, or 12C, respectively. Note that the development devices 11K, 11Y, 11M, and 11C differ only in toners T contained in the toner containers 12K, 12Y, 12M, and 12C, respectively, and are identical in the other configurations. Therefore, the following explanations are given by omitting the codes K, Y, M, and C that identify the respective development devices.

The development device 11 is provided with the photosensitive drum 14, a charging roller 15 as a charging member that charges the photosensitive drum 14, a development roller 16 that forms a toner image by supplying the toner T to an electrostatic latent image recorded on the photosensitive drum 14 through an exposure performed from the exposure device 13 based on print data, a development blade 17 that is disposed in a state of contacting with the development roller 16 and forms a toner layer on the surface of the development roller 16, a supply roller 18 that supplies the toner T to the development roller 16, and a cleaning blade 51 that removes residual toner on the photosensitive drum 14.

Usable as the photosensitive drum 14 is the one where a charge generation layer of about 0.5 mm in film thickness and a charge transportation layer of about 18 μm in film thickness are sequentially stacked on an aluminum raw pipe as a conductive supporting body of about 0.8 mm in thickness and about 30 mm in outer diameter. Here, listed as possible charge generation materials used for the charge generation layer are, for example, inorganic photoconductive materials such as selenium and its alloys, arsenic selenide compounds, cadmium sulfide, and zinc oxide, and various kinds of organic pigments and dyes such as phthalocyanine, azo coloring matter, quinacridone, polycyclic quinone, pyrylium salts, thiapyrylium salts, indigo, thioindigo, anthanthrone, pyranthrone, and cyanine. Also, listed as possible charge transportation materials used for the charge transportation layer are, for example, electron-donating substances such as heterocyclic compounds such as carbazole, indole, imidazole, oxazole, pyrazole, oxadiazole, pyrazoline, and thiadiazole, aniline derivatives, hydrazone compounds, aromatic amine derivatives, stilbene derivatives, and polymers having groups comprising these compounds on the main chain or a side chain.

In this embodiment, an alumite treatment is applied to the aluminum raw pipe surface as the conductive supporting body, and for the charge generation layer, phthalocyanine was used as the charge generation material, and a polyvinylacetal resin was used as the binder resin. Also, for the charge transportation layer, a hydrazone-based compound was used as the charge transportation material, a polycarbonate-based resin was used as the binder resin, and an antioxidant was further added.

The charging roller 15 uniformly charges the surface of the photosensitive drum 14. As shown in FIG. 3, the charging roller 15 is provided with an axial body 15a such as a shaft, a conductive base layer 15b around it, and a surface layer 15c on the outermost surface for adding durability and contamination resistance.

Usable as the axial body 15a is a metal having prescribed rigidity and sufficient conductivity, such as iron, copper, brass, stainless steel, aluminum, and nickel. Also, even a non-metallic materials such as resin moldings with conductive particles dispersed or ceramics can be used as far as provided with conductivity and appropriate rigidity. Further, the shape can be made a hollow pipe shape, other than a roll shape.

Often used for the conductive base layer 15b is an elastic body containing rubber, thermoplastic elastomer, resin, or the like, so that a nip part can be formed between it and the photosensitive drum 14. The conductive base layer 15b is not limited to a single layer but can be provided with a multilayer structure having two layers or more as necessary, and a resistance adjustment, contamination prevention of the photosensitive drum 14, or a hardness adjustment, or the like are performed.

Usable as the material constituting such conductive base layer 15b is, for example, a rubber composition having as its principal ingredient one kind or two kinds or more mixed of epichlorohydrin rubber, ethylene-propylene rubber (EPM, EPDM), nitrile rubber (NBR), chloroprene rubber (CR), urethane rubber, silicone rubber, etc. Among them, especially epichlorohydrin rubber is often used as the principal ingredient.

Then, usable as the epichlorohydrin rubber is, for example, one kind or two kinds or more mixed of an epichlorohydrin homopolymer (CO), a polymer of epichlorohydrin and ethylene oxide (ECO), a copolymer of epichlorohydrin and allylglycidylether (GCO), a copolymer of epichlorohydrin and propylene oxide, a copolymer of epichlorohydrin, ethylene oxide, and allylglycidylether (GECO), a copolymer of epichlorohydrin, propylene oxide, and allylglycidylether, a copolymer of epichlorohydrin, ethylene oxide, propylene oxide, and allylglycidylether, and the like. Among them, it is preferred to use a copolymer containing ethylene oxide, especially ECO or GECO.

As the crosslinking agent component of the base polymer, appropriate crosslinking agent and promoting agent for the kind of each composition can be used. For example, in the case of using epichlorohydrin rubber, at least one kind or two kinds together of thiourea-based crosslinking agent and its promoting agent can be used. Also, the base polymer can further contain at least one kind of additive such as crosslinking aid, conductive agent, acid-accepting agent, antioxidant, anti-aging agent, processing aid, filler, pigment, flame retardant, neutralizer, and foam suppressor.

Note that the conductive characteristic of the conductive base layer 15b should preferably be the ionic conductivity, and that the resistance value of the charging roller 15 should preferably be 10⁶-10⁹Ω. In general, if the resistance value is too large, a poor printed image occurs due to charging unevenness or charging failure on the photosensitive drum surface. Conversely, if the resistance value is too small, a leak occurs due to scratches etc. on the photosensitive drum surface, generating a good printed image. In order to obtain a proper resistance value region, it is required to use an ionic conductive material as the conductive base layer material in advance, or provide it with prescribed conductivity by adding an ionic conductive agent, carbon black, a metal oxide, or the like. Note that although either the electronic conductivity or the ionic conductivity can be used as the conductivity of the conductive base layer, because partial unevenness in resistance tends to influence the charging unevenness of the photosensitive drum, in order to suppress resistance unevenness, the ionic conductivity is often preferred to the electronic conductivity.

By the way, hardness of the surface of the conductive base layer (surface layer) should desirably be within a range of 70-80° in ASKER C hardness. As the outside surface shape of the conductive base layer, prescribed polishing marks and surface roughness can be formed by cutting, polishing, molding, etc.

Then, by performing prescribed surface treatment, coating, or ultraviolet ray irradiation onto the outside surface of the conductive base layer, ten-point mean roughness Rz as a charging roller can be made within a preferable range of 8-17 μm for example.

Listed as materials usable for the outside surface treatment or coating of the conductive base layer are, for example, isocyanate compound, acrylic resin, urethane resin, alkyd resin, amide resin, phenol resin, fluorine resin, silicone resin, modified resins of these, and the like. These may be used standalone, or two kinds or more can be used together.

Also, in order to adjust the resistance value (give conductivity) on the outside surface of the conductive base layer, it is possible to add appropriately a conductive agent such as an ionic conductive agent, carbon black, and a metal oxide. Further, as necessary, a filler, a stabilizer, an ultraviolet ray absorber, an antistatic agent, a reinforcing agent, a lubricant, a release agent, a flame retardant, etc. can be appropriately added. Also, there is a method to form an oxide film as a protective film by oxidizing the conductive base layer surface by irradiating it with ultraviolet ray. By applying the above-mentioned treatment to the surface of the conductive base layer (surface layer), releasability is given, thereby reducing adherence of the toner T flung up from the photosensitive drum or an external additive peeled off the toner T.

The charging roller 15 of this embodiment employs a metallic axial body 15a having an outer diameter φ of 6 mm as a conductive supporting body, and an elastic body made of epichlorohydrin rubber (ECO) as the primary ingredient for the conductive base layer 15b, making the base layer outer diameter φ12 mm. Also, by adding particles to the surface layer 15c, adherence of the external additive derived from the toner onto the surface of the charging roller 15 is reduced, suppressing contamination of the photosensitive drum 14.

A large number of particles are added to the interior of the surface layer 15c, and its outer circumferential face is roughened by the particles. Here, the thickness of the surface layer 15c should preferably be set within a range of 3-30 μm.

Listed as the layer forming material for the surface layer 15c (part excluding the particles), for example, are ethylene-propylene rubber, urethane rubber, butadiene rubber, styrene-butadiene rubber, acrylic rubber, nitrile rubber, polyurethane-based elastomer, polyester, nylon, etc. Also, other than the above, a conductive agent or the like may be added as necessary. In this embodiment, nylon was used as the layer forming material for the surface layer 15c.

Then, the particles contained in the surface layer 15c should preferably have an mean particle size of 5-30 μm for making the surface shape proper, and the particle size distribution should desirably be uniform. Also, although the particle shape is not limited to a spherical shape, it should preferably have a shape closer to a true sphere. Also, as the electric characteristics of the particles, the volume resistance should preferably be larger than that of the layer forming material of the particle-containing layer. This is a consideration to prevent electric current from concentrating to the particles.

Note that usable as the material of the particles are, for example, macromolecular organic polymers such as nylon resin, acrylic resin, urethane resin, fluorine resin, polyamide resin, and phenol resin, non-metallic organic materials such as silica, alumina, and calcium carbonate, etc.

Note that a bias voltage of the same polarity as the toner T is applied to the charging roller 15 from an unshown charging roller power supply.

The development roller 16 has urethane rubber having carbon black dispersed disposed on the outer circumference of a shaft made of metal such as stainless steel, and the isocyanate treatment is applied to the surface. For example, the outer diameter φ of the development roller 16 can be made 19.6 mm, and it is disposed in contact with the surface of the photosensitive drum 14 and has a toner adhere to an electrostatic latent image formed on the photosensitive drum 14 while rotating, thereby developing a toner image. Note that a bias voltage of the same polarity as or the opposite polarity to the toner T is applied to the development roller 16 from an unshown development roller power supply.

The development blade 17 is, for example, a plate-shape member configured by bending a metal (such as stainless steel) plate of 0.08 mm in thickness, and its one end is disposed so as to contact with a prescribed position of the surface of the development roller 16. The development blade 17 regulates the layer thickness of the toner T supplied to the development roller 16 from the supply roller 18.

The supply roller 18 has a semiconductive foamed silicone sponge layer on the outer circumference of a metal (such as stainless steel) shaft. For example, the outer diameter φ of the supply roller 18 can be made 15.5 mm, and it is disposed in contact with the surface of the development roller 16 and supplies the toner T supplied from the toner container 12 to the development roller 16 while rotating. Note that a bias voltage of the same polarity as or the opposite polarity to the toner T is applied to the supply roller 18 from an unshown supply roller power supply.

The cleaning blade 51, for example, has a blade member comprising a rubber member made of polyurethane, is disposed in parallel to the rotation axis direction of the photosensitive drum 14, and has its base part attached and fixed to a supporting board of high rigidity so that its tip contacts with the surface of the photosensitive drum 14. The cleaning blade 51 cleans the surface of the photosensitive drum 14 by scraping off the toner T remaining on the surface of the photosensitive drum 14. Note that the cleaning blade 51 of this embodiment employs SECC (electrogalvanized steel sheet) as the supporting board, and the blade member made of polyurethane.

Usable as the toner T is, for example, a one-component nonmagnetic one made by the pulverization method, and unshown fine particles, called an external additive, made of silica, titanium oxide, or the like of several to several tens of nanometers in size are added for adjusting the flowability and charging characteristics. Also, the added amount of this external additive and a coloring agent for colorization differ among the toners.

Note that the toner container 12 is a box-shape member provided with a containing space to contain unused toner T, and a shutter member that can slide in a prescribed direction to form an opening part is formed on its bottom part to allow toner replenishment to the supply roller 18.

Next, explained are the print operations of the printer 10 provided with the above-mentioned configuration.

First of all, for example, once a control command and print data relating to executing printing are inputted from an unshown host device such as a personal computer, the photosensitive drum 14 starts rotating in the arrow direction in FIG. 2 at a prescribed circumferential velocity.

Simultaneously, the unshown charging roller power supply applies the prescribed bias voltage to the charging roller 15, which uniformly charges the surface of the photosensitive drum 14 while rotating in the direction of the arrow in FIG. 2.

Next, the unshown exposure controller controls the exposure device 13 so as to radiate light based on the inputted print data, and has an electrostatic latent image formed on the photosensitive drum 14.

The development blade 17 disposed on the prescribed position of the surface of the development roller 16 forms the toner T supplied from the supply roller 18 that rotates in the direction of the arrow in FIG. 2 into a uniform-thickness layer. Then, a toner image is developed by the toner T adhering to the part of the electrostatic latent image by lines of electric force corresponding to the electrostatic latent image formed on the photosensitive drum 14 between the development roller 16 and the photosensitive drum 14.

In accordance with the above-mentioned toner image forming operation, the hopping roller 32 provided on the upper part of the sheet feeding cassette 31 forwards the recording medium 20 to the medium carrying route 21. The recording medium 20 forwarded to the medium carrying route 21 is carried to the transfer belt unit 35 while its skew is being corrected by the carrying roller 33.

Then, the toner image is transferred onto the recording medium 20 by the transfer roller 37 to which the prescribed bias voltage is applied from the unshown transfer power supply.

The toner images formed in the development devices 11 are transferred sequentially to the recording medium 20. Afterwards, the recording medium 20 is carried to the fuser unit 41. Then, the toners T are melted by heat given from the heat application roller 41a, and further by being press-contacted in a press-contact part formed by the heat application roller 41a and the backup roller 41b, the toner images are fused on the recording medium 20. The recording medium 20 with the toner images fused is ejected to the ejection stacker 43 by the ejection roller 42, finishing a series of print operations.

Here, explained is the cleaning process of the photosensitive drum 14 after the toner image transfer. As shown in FIG. 2, there may be some transfer residual toner T′ remaining on the photosensitive drum 14 after the toner image transfer. This transfer residual toner T′ is removed by the cleaning blade 51 in the cleaning process.

As mentioned above, the cleaning blade 51 is disposed in parallel to the rotation axis direction of the photosensitive drum 14, and its base part is attached and fixed to the supporting board of high rigidity so that its tip contacts with the surface of the photosensitive drum 14. When the photosensitive drum 14 rotates centering on its rotation axis in a state where the cleaning blade 51 is in contact with the surface of the photosensitive drum 14, the cleaning blade 51 removes the transfer residual toner T′ from the photosensitive drum 14. Through this cleaning process, the photosensitive drum 14 is repeatedly utilized.

However, the cleaning blade 51 cannot completely remove the transfer residual toner T′ on the surface of the photosensitive drum 14, very small foreign bodies that are hard to be removed, especially silica and the like used as the external additives for the toner T can slip through the cleaning blade 51, and these foreign bodies would accumulate on the charging roller 15. If this accumulated material is not removed, generating a residual part, the accumulated material remains in a streak shape on the circumferential surface of the charging roller 15. Because the photosensitive drum 14 cannot be sufficiently charged on the part where the accumulated material remains, streak-shape unevenness occurs on the electrostatic latent image formed on the surface of the photosensitive drum 14, and on the toner image made by developing this, streak-shape unevenness also occurs.

This invention has made it possible to suppress the occurrences of charging lateral streaks by adding particles of different particle sizes (large particles and small particles) to the interior of the surface layer 15c of the charging roller 15 to provide the surface with recesses and projections, thereby stabilizing its charging characteristics to the photosensitive drum 14. Explained below in detail is the evaluation method of this embodiment.

Compared in this evaluation were a charging roller of the conventional technology having one kind of particles added to the surface layer (one kind of particles: mean particle size 13 μm) and the charging roller of this embodiment having two kinds of particles of different particle sizes added to the surface layer (large particles: mean particle size 30 μm, small particles: mean particle size 20 μm).

In order to judge the surface shapes of these charging rollers, observations were performed at a magnification of 1000 using an ultra-deep shape measuring microscope VK-8500 (manufactured by KEYENCE Corporation). A shape analysis of each of the obtained images was performed to measure projection heights on the surface of the surface layer. As the projection height, heights of part with a particle and part without a particle (sea part) were measured, and their difference was regarded as the projection height.

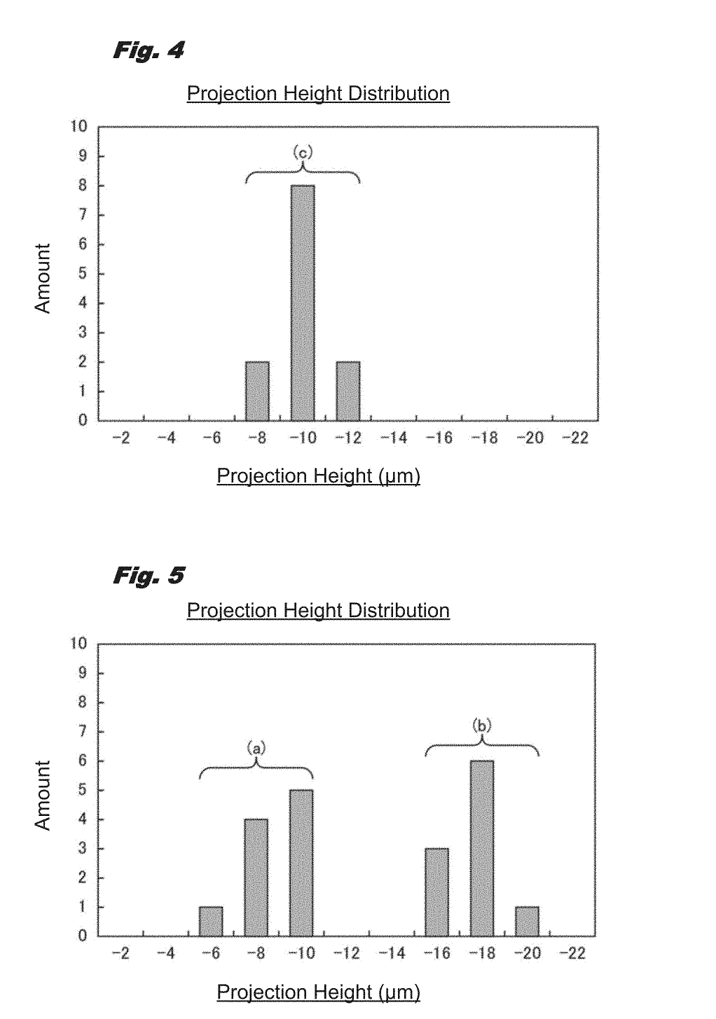

In the charging roller of the conventional technology, as shown in a projection height distribution in FIG. 4, because one projection height peak was observed in a region (c) within a range of about 7-13 μm, it was confirmed that there were one kind of particles. On the other hand, because one projection height peak each was observed in both a region (a) within a range of about 5-11 μm and a region (b) within a range of about 15-21 μm, it was confirmed that there were two kinds of particles.

Then, continuous printing tests were performed using the charging roller of the conventional technology (one kind of particles) and the charging roller of this embodiment (two kinds of particles).

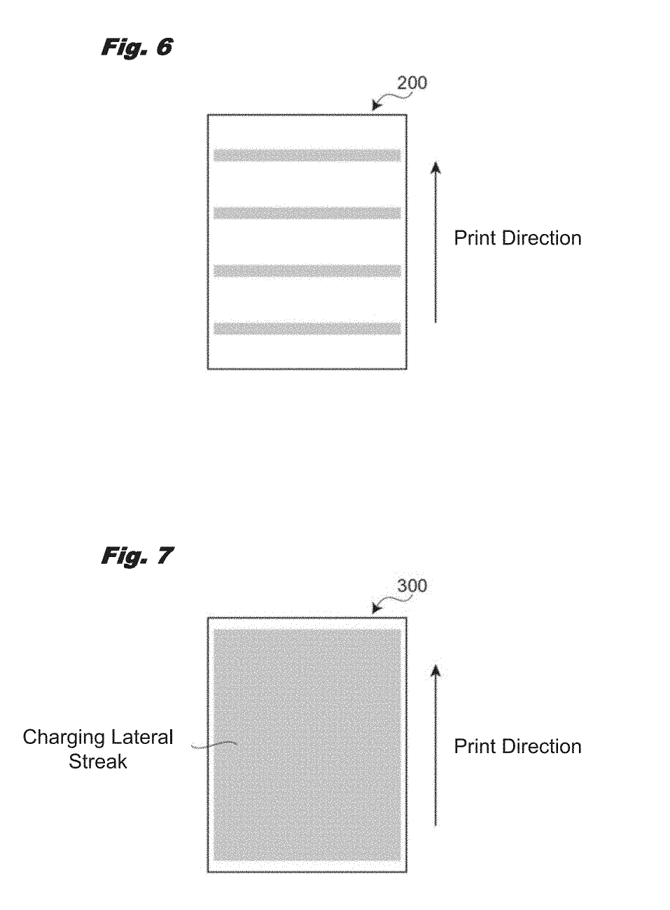

In each of the continuous printing tests, the development device with the respective charging roller mounted was attached to a printer (C711dn manufactured by Oki Data Corporation), and continuous printing of 2000-3500 sheets/day was performed for 10 days, in total 30000 sheets, with a print density of 5% coverage and A4 paper longitudinal feed. The continuous printing tests were performed in an ordinarily room temperature and humidity (temperature 23±3° C. and humidity 55±10% RT) using magenta as the toner T. Note that FIG. 6 shows an example of a recording medium 200 printed at a print density of 5% coverage.

Before starting and after finishing a day of continuous printing, half-tone (2×2) and 1×1 pattern printings were performed on A4 plain paper, and the presence or absence of a charging lateral streak was checked. If a charging lateral streak occurs, the charging lateral streak as shown in FIG. 7 occurs on a recording medium 300. Note that charging lateral streaks tend to occur more often in the edge part than the central part.

Then, judgment of the occurrences of charging lateral streaks was made by dividing the level into five stages as shown below.
Level 5: No charging lateral streak occurred.
Level 4: Very little charging lateral streaks occurred.
Level 3: Faint charging lateral streaks occurred.
Level 2: A small amount of charging lateral streaks occurred.
Level 1: A significant amount of charging lateral streak occurred.

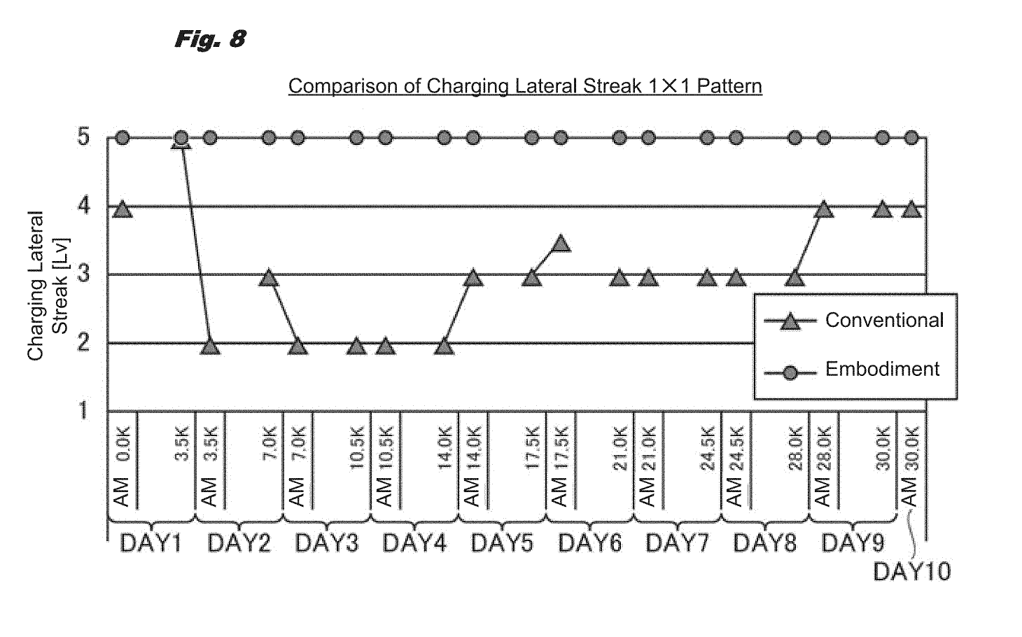

FIG. 8 is a compilation of the judgment results of the occurrences of charging lateral streaks in the order of time sequence as a result of the continuous printing tests. Note that because in the halftone (2×2) no occurrence of charging lateral streaks was recognized from the initial period after starting the tests until finishing the continuous printing, the printing results of the 1×1 pattern were reflected.

As is evident from FIG. 8, as a result of performing the continuous printing tests using the charging roller of the conventional technology, it became evident that charging lateral streaks that did not occur in the half tone (2×2) printing occurred at the levels 2-3 in the 1×1 pattern printing. Because these charging lateral streaks were not seen in the image central part but occurred in the image edge part, it is believed that the lateral streak levels on the charging roller edge part were reflected.

On the other hand, as a result of performing the continuous printing tests using the charging roller of this embodiment, no occurrence of charging lateral streaks was recognized from the initial period after starting the tests until finishing the continuous printing. Also, although data are not shown, among the two kinds of particles added, even when particles of 10 μm in mean particle size were used as the small particles, no occurrence of charging lateral streaks was recognized from the initial period after starting the tests until finishing the continuous printing. Based on these results, it was confirmed that occurrences of charging lateral streaks could be suppressed by adding two kinds of particles of different particle sizes to the interior of the surface layer of the charging roller so that the projection height distribution of the surface of the charging roller shows two peaks.

As stated above, according to this embodiment, by adding two kinds of particles of different particle sizes to the surface layer of the charging roller, the occurrences of charging lateral streaks could be suppressed.

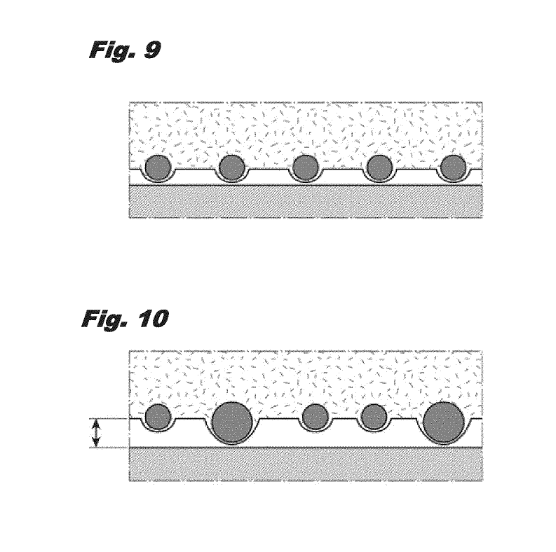

Here, shown in FIG. 9 is a cross-sectional model when one kind of particles are added to the surface layer of the charging roller. Roughness (recesses and projections) is formed by the added particles, and charging is performed to the photosensitive drum. In that process, a certain degree of roughness is formed to secure a space. However, a discharge in this example occurs between the face part between protruding particles (sea part) of the charging roller and the face part of the photosensitive drum, and it is believed that if an accumulated material or the like exists on the surface layer of the charging roller, because the charge becomes uneven and thus unstable, charging lateral streaks occur.

On the other hand, shown in FIG. 10 is a cross-sectional model when two kinds of particles are added to the surface layer of the charging roller. As in this embodiment, by adding two kinds of particles of large particles and small particles of different particle sizes, an effect occurred in each of those particles. In other words, the large particles secured a certain extent of space by contacting with the face part of the photosensitive mm, and the small particles keep a certain distance with the face part of the photosensitive drum and produce recesses and projections on the surface of the charging roller. Then, when a voltage is applied, because the projecting parts of the small particles become discharge start points, charges in the axial direction of the charging roller are suppressed, and a discharge from the charging roller to the photosensitive drum is performed. Therefore, it is believed that the occurrences of charging lateral streaks were suppressed as a result of performing a uniform discharge to the surface of the photosensitive drum with charging unevenness suppressed.

As stated above, according to this embodiment, an image forming apparatus can be offered that can suppress occurrences of streaks derived from a charging member on printed images and allow obtaining fine printed images.

### Second Embodiment

Explained in the first embodiment was a form where fine printed images can be obtained by suppressing occurrences of streaks derived from a charging member on printed images by dispersing large and small particles of different particle sizes in the surface layer 15c of the charging roller 15 and regulating the projection height distribution derived from the particles in the surface layer 15c. Explained in this embodiment is a form where fine printed images can be obtained by suppressing occurrences of streaks derived from a charging member on printed images by regulating the occupied area ratio of projections in a microscope observation image of the surface layer 15c of the charging roller 15 having large and small particles of different particle sizes dispersed in the same manner as in the first embodiment. Note that because the configurations and operations of a printer, development devices, especially a charging roller, etc. can be made the same as the printer 10, the development devices 11K, 11Y, 11M, and 11C, the charging roller 15, etc., the same codes are given to the same configurations, and explanations on their operations are omitted.

The charging roller 15 of this embodiment is also provided with recesses and projections on its surface by adding two kinds of particles of different particle sizes (large particles: mean particles size 30 μm, small particles: mean particle size 20 μm) to the interior of the surface layer 15c of the charging roller 15.

Then, in order to judge the surface shape of the charging roller 15, in other words the large particles and the small particles dispersed in the surface layer 15c, an analysis was performed using the ultra-deep shape measuring microscope VK-8500 (manufactured by KEYENCE Corporation).

In the microscopic observations using the ultra-deep shape measuring microscope that is a laser confocal microscope, the gain was set to 583 and the offset to 1821 as an example of image acquisition conditions in performing the microscopic observations.

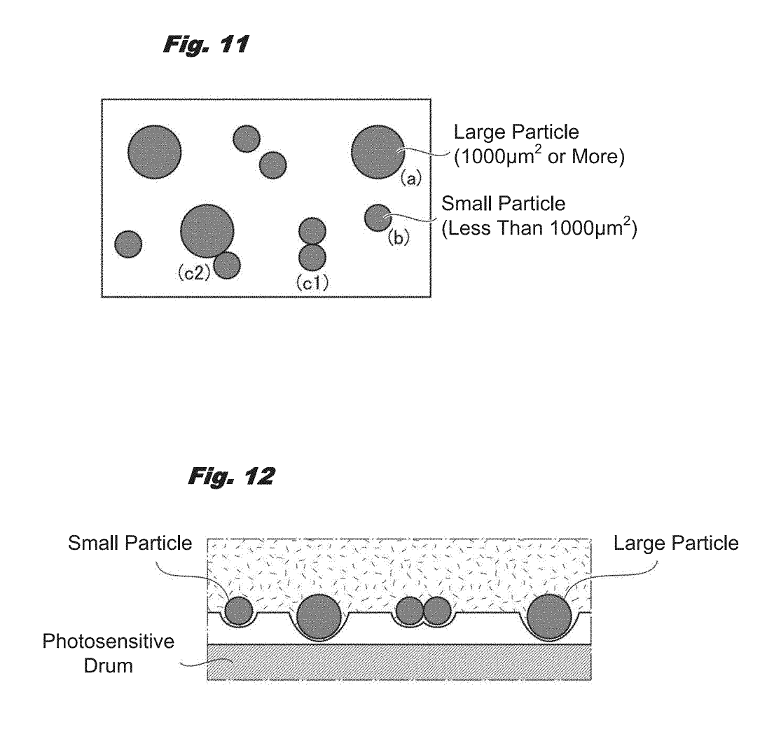

Shown in FIG. 11 is a model diagram of an image obtained by a microscope observation (below, called a field of view image). In this embodiment, as a method to distinguish the large particles and the small particles, an attention was paid to the area of each particle in the field of view image of the microscope. Specifically, each particle (image) observed in the field of view image is assumed to be a circle, and the area of the circle was measured.

In this embodiment, particles of 1000 μm² or more in the observed circle area are regarded as large particles (FIG. 11(a)), and particles of less than 1000 μm² as small particles (FIG. 11 (b)). Note that as shown in FIG. 11 (c1) and (c2), when particles overlap with each other, their respective areas were measured including the overlapped area. Also, in this embodiment, multiple microscopic observations were performed at a magnification of 1000, and the area ratio (occupied area ratio) of large particles and small particles included in a prescribed field of view area 0.06 mm² (height: about 0.2 mm×width: about 0.3 mm) obtained was measured for an evaluation. Note that as schematically shown in FIG. 11, the relation in the number of particles between the large particles and the small particles obtained by the microscopic observations in the condition of this embodiment was: large particles<small particles.

The continuous printing tests were performed by the same method as the tests explained in the first embodiment. In other words, the development device with the charging roller of this embodiment mounted was attached to the printer (C711dn manufactured by Oki Data Corporation), and continuous printing of 2000-3500 sheets/day was performed for 10 days, in total 30000 sheets, with a print density of 5% coverage and A4 paper longitudinal feed. The continuous printing tests were performed in an environment of temperature 23±3° C. and humidity 55±10% RH using magenta as the toner T.

Before starting and after finishing a day of continuous printing, half-tone (2×2) and 1×1 pattern printings were performed on A4 plain paper, and the presence or absence of charging lateral streaks was checked. The judgment of the occurrences of charging lateral streaks was made by dividing it three levels as described below.

◯: No charging lateral streak occurred.

Δ: Hardly detectable or slight charging lateral streaks occurred.

x: Lateral streaks occurred.

Note that the judgment levels in this embodiment have the following relation with the judgment levels explained in the first embodiment.

◯: Level 5 (Good)

Δ: Level 4 (Fine)

x: Levels 1-3 (Poor)

Listed in Table 1 as the continuous printing test results are the judgment results of the occurrences of charging lateral streaks expressed in the occupied area ratios of the large particles and the small particles in the field of view image (0.06 mm²). Also, listed in Table 2 are the judgment results of dirt occurrences expressed in the occupied area ratios of the large particles and the small particles in the field of view image in the same manner as in Table 1. Note that because in the halftone (2×2) almost no occurrence of charging lateral streaks was recognized from the initial period after starting the tests until finishing the continuous printing, the printing results of the 1×1 pattern were reflected.

As is evident from Table 1 also, the region of occupied area ratio where charging lateral streaks improve turned out to be 3-8% for the large particles and 10-25% for the small particles. Note that when the particle occupying area ratio was further increased, the judgment of charging lateral streaks is indicated as Δ. As indicated in the results in Table 2, this judgment resulted because poor images occurred due to dirt, making the judgment difficult.

Therefore, it was confirmed that the occurrences of charging lateral streaks could be suppressed by having the large particles occupy 3-8% and the small particles occupy 10-25% of the field of view area (0.06 mm²).

As stated above, according to this embodiment, by adding two kinds of particles of different particle sizes to the surface layer of the charging roller, the occurrences of charging lateral streaks could be suppressed in the same manner as in the first embodiment.

Shown in FIG. 12 is a cross-sectional model when two kinds of particles are added to the surface layer of the charging roller. By adding two kinds of particles of large particles and small particles of different particle sizes as in this embodiment, an effect occurred in each of the particles. In other words, the large particles secure a certain extent of space by contacting with the face part of the photosensitive drum, and the small particles produce recesses and projections on the charging roller surface by keeping a certain distance with the face part of the photosensitive drum. Then, when a voltage is applied, because the projecting parts of the small particles become discharge start points, charges in the axial direction of the charging roller are suppressed, and a discharge from the charging roller to the photosensitive drum is performed. Therefore, it is believed that the occurrences of charging lateral streaks were suppressed as a result of performing a uniform discharge to the surface of the photosensitive drum with charging unevenness suppressed. By the way, as is also evident from Tables 1 and 2, it is believed that if the occupied area of the large particles and the small particles is small in a prescribed field of view area, the charge becomes uneven, and a charging lateral stripe occurs. Conversely, it is believed that if the occupied area of the large particles and the small particles is small, the resistance of the charging roller rises, and the charging potential drops, causing dirt to occur.

Based on these, by mounting a charging roller with two kinds of particles of different particle sizes (large particles and small particles) added to the surface of the charging roller, it is possible to offer an image forming apparatus with a high image quality where charging lateral streaks are hard to occur. In this case, it is desirable that the large particles and the small particles occupy 3-8% and 10-25% of the field of view area (0.06 mm²), respectively, when observed under a microscopic. At this time, as explained in the first embodiment, it is believed that by configuring so that the projection heights of the large particles and the small particles relative to the charging roller surface have peaks within ranges of 5-11 μm and 15-21 μm, it is also possible to offer an image forming apparatus that can better suppress the occurrences of charging lateral streaks.

Although a printer was adopted as an example of an electrophotographic image forming apparatus in explaining this invention, this invention can be applied to copiers, facsimile machines, MFPs, etc.

Based on the above disclosure, it is noted that the large particles may have 10% range of the mean particle size. Accordingly, the mean particle size of the large particles may fall within 27-33 μm. In the similar practical view, the mean particle size of the small particles may fall within 10-20 μm.

What is claimed is:

1. An image forming apparatus, comprising:
an electrostatic latent image carrier that carries an electrostatic latent image,
a charging member that charges the electrostatic latent image carrier by contacting with the electrostatic latent image carrier, the charging member being rotatable around an axis, and
a development part that develops the electrostatic latent image by having a developer adhere to the electrostatic latent image, wherein
the charging member comprises an axial body that rotates around the axis, a conductive base layer provided around the axial body, and a surface layer provided on an outer circumferential face of the conductive base layer, and
surface projections are formed on the surface layer, of which a projection height distribution includes at least two peaks.

2. The image forming apparatus according to claim 1, wherein
the surface projections on the surface layer are composed with particles,
one of the peaks in the projection height distribution belongs to a group made of large particles, and
the other of the peaks belongs to another group made of small particles of which a mean particle size is smaller than that of the large particles.

3. The image forming apparatus according to claim 2, wherein
the projection height is calculated based on a result of measuring, by an ultra-deep shape measuring microscope, recesses and projections formed on the surface layer with the particles attached to the surface layer.

4. The image forming apparatus according to claim 2, wherein the mean particle size of the large particles is ranged within 27-33 μm

5. The image forming apparatus according to claim 2, wherein
the mean particle size of the small particles is ranged within 10-20 μm.

6. The image forming apparatus according to claim 1, wherein the one peak of the large particles is composed with surface projections of which heights are ranged within 5-11 μm, and the other peak of the small particles is composed with surface projections of which heights are ranged within 15-21 μm.

7. The image forming apparatus according to claim 1, wherein hardness of the surface layer is 70-80° in ASKER C hardness.

8. The image forming apparatus according to claim 1, wherein roughness of the surface layer is 8-17 μm in ten-point mean roughness Rz.

9. The image forming apparatus according to claim 1, wherein thickness of the surface layer is 3-30 μm.

10. The image forming apparatus according to claim 1, wherein the surface layer is made of nylon.

11. The image forming apparatus according to claim 1, wherein the conductive base layer is made of epichlorohydrin rubber.

12. The image forming apparatus according to claim 1, wherein the occupied area ratio of projection areas larger than 1000 μm² is ranged within 3-8%, and the occupied area ratio of projection areas smaller than 1000 μm² is ranged within 10-25% in a surface observation image region under a microscope.

13. An image forming apparatus, comprising:
an electrostatic latent image carrier that carries an electrostatic latent image,
a charging member that charges the electrostatic latent image carrier by contacting with the electrostatic latent image carrier, the charging member being rotatable around an axis, and
a development part that develops the electrostatic latent image by having a developer adhere to the electrostatic latent image, wherein
the charging member comprises an axial body that rotates around the axis, a conductive base layer provided around the axial body, and a surface layer provided on an outer circumferential face of the conductive base layer, and
in a surface observation image region that is a part of region of the surface layer seen from a microscope, the surface observation image region includes two different projection areas, one of the projection areas being large projection areas each of which is 1000 μm² or larger, and the other of the projection areas being small projection areas each of which is smaller than 1000 μm²,
an occupied area ratio of the large projection areas, that is determined by how degrees the large projection areas occupying the surface observation image region, is ranged within 3-8%, and
an occupied area ratio of the small projection areas, that is determined by how degrees the small projection areas occupying the surface observation image region, is ranged within 10-25%.

14. The image forming apparatus according to claim 13, wherein
the small projection areas is formed with particles of which mean particle size is ranged within 10-20 μm.

15. The image forming apparatus according to claim 14, wherein
the large projection areas are formed with particles of which mean particle size is about 30 μm.

16. The image forming apparatus according to claim 15, wherein
the number of the particles forming the large projection arears is smaller than that of the particles forming the small projection areas in the surface observation image region.

17. The image forming apparatus according to claim 13, wherein
the surface observation image region corresponds to a field of view area of an observer, and
the occupied area ratio of projection areas is an occupied area relative to the field of view area obtained when observed at a magnification of 1000 using an ultra-deep shape measuring microscope.

18. The image forming apparatus according to claim 17, wherein
a field of view area is 0.06 mm².
